(19) United States
(12) Patent Application Publication
(10) Pub. No.: US 2014/0188631 A1
(43) Pub. Date: Jul. 3, 2014

(54) BID SYSTEM FOR ADVERTISEMENT OFFERINGS

(71) Applicant: BANK OF AMERICA CORPORATION, Charlotte, NC (US)

(72) Inventor: David M. GRIGG, Rock Hill, SC (US)

(73) Assignee: BANK OF AMERICA CORPORATION, Charlotte, NC (US)

(21) Appl. No.: 13/732,381

(22) Filed: Jan. 1, 2013

(51) Int. Cl. G06Q 30/02

(52) U.S. Cl. CPC G06Q 30/0275
USPC 705/14.71

(57) ABSTRACT

Systems and methods for a proposal system for advertisement offerings are provided. In an embodiment, the system and method receive at least one criteria for an advertisement from a user; determine a subset of advertisers from a plurality of advertisers stored in a database, wherein the subset of advertisers are determined based on the at least one criteria; request proposals from the subset of advertisers to provide the advertisement; receive proposals from the advertisers in response to the request for proposals; and provide the proposals to the user. The system and method provides for a bidding system that allows users to specifically target advertisements and receives proposals from advertisers capable of meeting the user's requirements. In some embodiments, the system assists in evaluation of the proposals and/or facilitates implementation of an advertisement once a proposal is selected by the user.

### BACKGROUND

Individuals and businesses often desire to provide an advertisement to potential customers but do not know who can meet the criteria that the individual or business desires for the target audience. Numerous different advertisers have different capabilities and a person may not know which ones can meet all of the person's criteria. Also, even if a person finds an advertiser that may be able to meet the person's criteria, the person has no way of evaluating the advertiser's offer. Thus, people have a difficult time finding advertisers that meet their needs while still being effective.

### BRIEF SUMMARY

The embodiments provided herein are directed to a bidding system for advertisements. In some embodiments of the system, the system includes a computer apparatus including a processor and a memory; and a software module stored in the memory, comprising executable instructions that when executed by the processor cause the processor to complete a series of steps. In an embodiment, the series of steps includes receiving at least one criteria for an advertisement from a user; determining a subset of advertisers from a plurality of advertisers stored in a database, wherein the subset of advertisers are determined based on the at least one criteria; requesting proposals from the subset of advertisers to provide the advertisement; receiving proposals from the advertisers in response to the request for proposals; and providing the proposals to the user.

In a further embodiment, the system also includes executable instructions that when executed by the processor cause the processor to evaluate the proposals and provide an evaluation of the proposals to the user. The system may evaluate the proposals based on historic advertisement and response data, and wherein the response data is based on transaction history data provided by a financial institution. In some embodiments, the evaluation provides an evaluation of the proposal based on an effectiveness of the advertisement and a cost efficiency of the advertisement. In an embodiment, the system provides suggested criteria to the user based on historical transaction data of customers. The system may also receive advertising data from the advertising provider, wherein the advertising data is associated with a previous advertising campaign. In some embodiments, the previous advertising campaign meets at least one of the criteria of the user.

In a further aspect, a computer program product for providing a bid system for advertisement offerings is provided. In some embodiments, the computer program product includes a non-transitory computer readable storage medium having computer readable program code embodied therewith, the computer readable program code comprising: computer readable program code configured to receive at least one criteria for an advertisement from a user; computer readable program code configured to determine a subset of advertisers from a plurality of advertisers stored in a database, wherein the subset of advertisers are determined based on the at least one criteria; computer readable program code configured to request proposals from the subset of advertisers to provide the advertisement; computer readable program code configured to receive proposals from the advertisers in response to the request for proposals; and computer readable program code configured to provide the proposals to the user.

In an embodiment, the computer program product also includes computer readable program code configured to evaluate the proposals and provide an evaluation of the proposals to the user. In some embodiments, the computer program product evaluates the proposals based on historic advertisement and response data, and wherein the response data is based on transaction history data provided by a financial institution. For example, the evaluation may provide an evaluation of the proposal based on an effectiveness of the advertisement and a cost efficiency of the advertisement. Still further, a computer readable program code configured to receive advertising data from the advertising provider, wherein the advertising data is associated with a previous advertising campaign may be included. In some embodiments, the previous advertising campaign meets at least one of the criteria of the user.

In a still further aspect, a method for providing a bid system for advertisement offerings is provided. In some embodiments, the method includes receiving at least one criteria for an advertisement from a user; determining, via a computing device processor, a subset of advertisers from a plurality of advertisers stored in a database, wherein the subset of advertisers are determined based on the at least one criteria; requesting proposals from the subset of advertisers to provide the advertisement; receiving proposals from the advertisers in response to the request for proposals; and providing the proposals to the user.

The method may also include evaluating the proposals; and providing an evaluation of the proposals to the user. In some embodiments, the method evaluates the proposals based on historic advertisement and response data, and wherein the response data is based on transaction history data provided by a financial institution. In still further embodiments, the evaluation provides an evaluation of the proposal based on an effectiveness of the advertisement and a cost efficiency of the advertisement. The method may also include providing suggested criteria to the user based on historical transaction data of customers. Still further, the method may include receiving advertising data from the advertising provider, wherein the advertising data is associated with a previous advertising campaign. In some embodiments, the previous advertising campaign meets at least one of the criteria of the user.

The features, functions, and advantages that have been discussed may be achieved independently in various embodiments or may be combined with yet other embodiments, further details of which can be seen with reference to the following description and drawings.

### BRIEF DESCRIPTION OF THE SEVERAL VIEWS OF THE DRAWINGS

The present embodiments are further described in the detailed description which follows in reference to the noted plurality of drawings by way of non-limiting examples of the present embodiments in which like reference numerals represent similar parts throughout the several views of the drawings and wherein:

FIG. 1 is a flowchart illustrating a system and method for a proposal system for advertisement offerings in accordance with various embodiments;

FIG. 2 provides a block diagram illustrating a system and environment for distributing data related to offer advertisements in accordance with various embodiments;

FIG. 3 provides a block diagram illustrating the distribution system, the user system, and the first advertising channel system of FIG. 2, in accordance with various embodiments; and

FIGS. 4A and 4B is a mixed block and flow diagram for providing a proposal system for advertisement offerings, in accordance with various embodiments.

### DETAILED DESCRIPTION

The embodiments presented herein are directed to systems and methods for providing a proposal system for advertisement offerings. In some embodiments, a system that receives criteria for a desired advertisement from a user and requests proposals or proposals from advertisers is provided. The system assists users in determining which advertisers are capable of meeting the user's criteria and in evaluating the proposals provided by the advertisers. Other embodiments are directed to facilitating the advertisement when the user selects a proposal from an advertiser.

The embodiments of the invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present embodiments of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present embodiments of the invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present embodiments of the invention are described below with reference to flowchart illustrations and/or block diagrams of methods, apparatus (systems) and computer program products according to embodiments of the embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

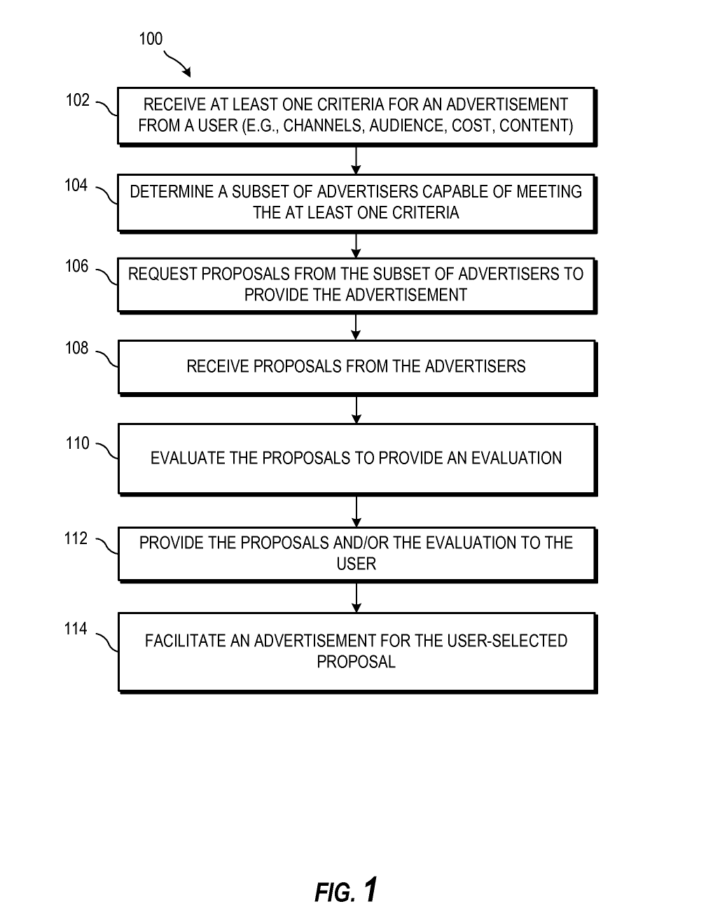

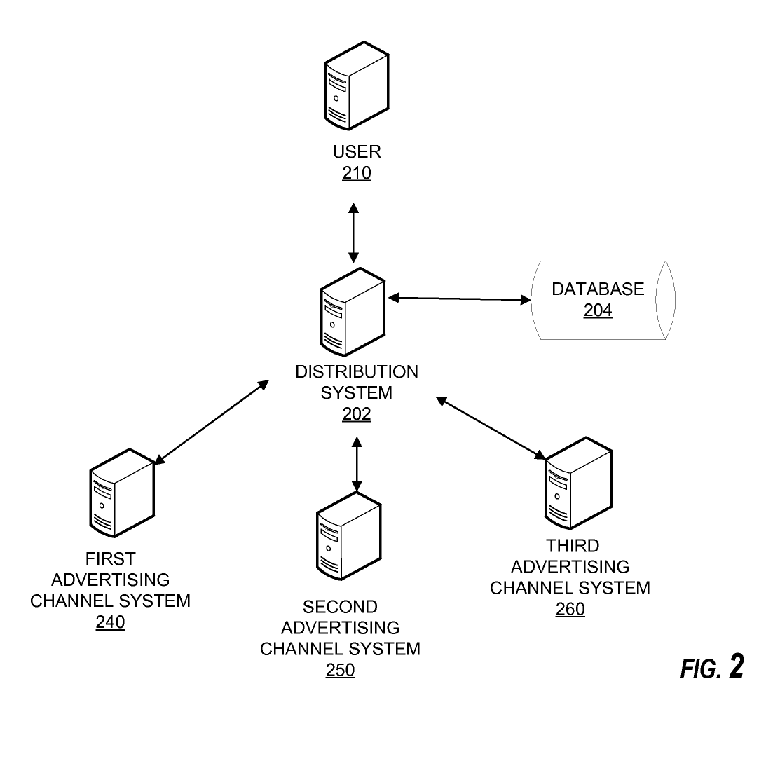

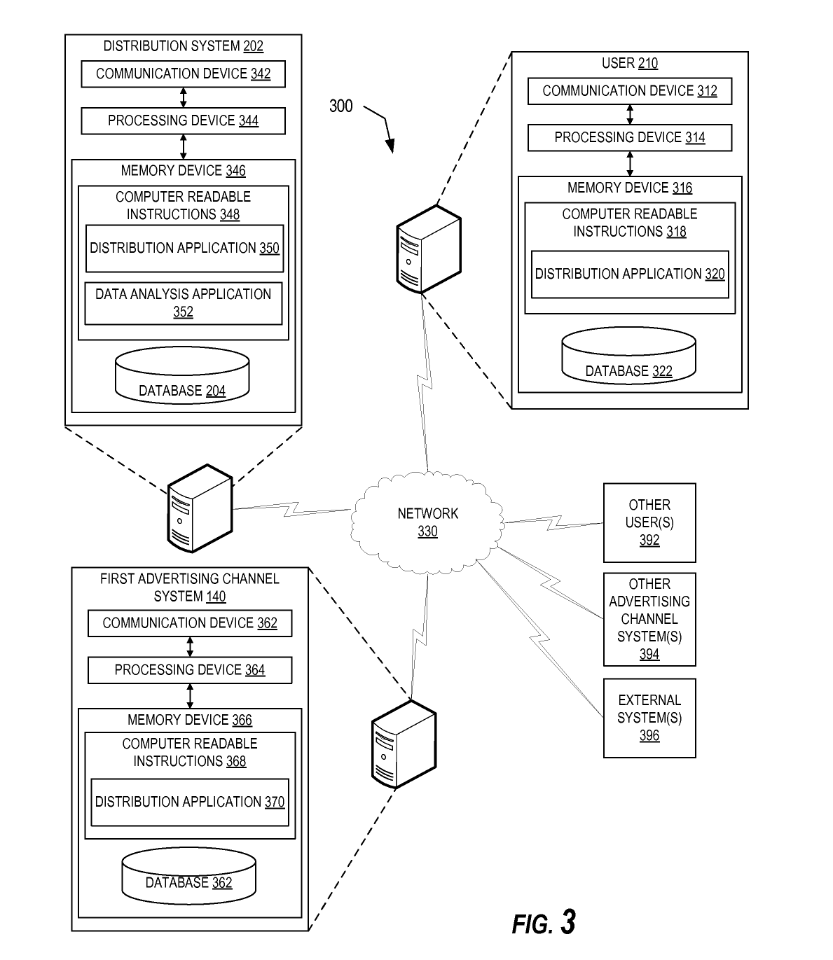

FIG. 1 illustrates a flowchart providing an overview of a process 100 for providing a proposal system for advertisement offerings. One or more devices, such as the one or more mobile devices and/or one or more other computing devices and/or servers of FIG. 2 and FIG. 3 can be configured to perform one or more steps of the process 100. In some embodiments, the one or more devices performing the steps are associated with a financial institution. In other embodiments, the one or more devices performing the steps are associated with a business, partner, third party, social network, offer provider, and/or user.

In general, the process 100 includes receiving at least one criteria for an advertisement from a user; determining, via a computing device processor, a subset of advertisers from a plurality of advertisers stored in a database, wherein the subset of advertisers are determined based on the at least one criteria; requesting proposals from the subset of advertisers to provide the advertisement; receiving proposals from the advertisers in response to the request for proposals; and providing the proposals to the user.

As illustrated at block 102, in some embodiments one or more criteria are received for an advertisement from a user. In some embodiments, the user is a merchant desiring to begin or continue an advertising campaign. For example, the user may be a small business that wants to create a new advertisement to target a specific demographic of potential customers. The small business may want to create an advertisement that will be presented to all new homeowners living in the southern United States. In another embodiment, the user is an individual, such as a self-employed consultant or professional, that wants to target businesses and offer consulting services. The user may be a non-profit, educational, government, or charitable organization that is attempting to provide information to or solicit input from a population of individuals or businesses. For example, a non-profit may desire to provide notice of services that the non-profit provides to all individuals that are living in a region where the non-profit's services are needed. Similarly, a charitable organization may solicit donations or provide an advertisement for a fundraiser. The users may include online retailers, brick and mortar retailers, manufacturers, product providers, whole sale providers, third parties associated with merchants (e.g., distributors), and the like.

As used herein, the word “criteria” means a desired feature of an advertisement. For example, the criteria may relate to the target audience for an advertisement, the channel or channel through which the advertisement will be presented, the geographic scope and location of an advertisement, the timeliness of an advertisement, the costs associated with the advertisement, and the like. Given the detailed information available to financial institutions, whom in some embodiments are the providers of the distribution system, users are able to create fine distinctions regarding criteria for advertisements. For example, users may provide criteria related to income, cash flow, balance information, home ownership, credit-worthiness, or other criteria related to recipients of advertisements wherein the data related to the criteria are known by the financial institution.

In some embodiments, the criteria include a type of advertising channel (e.g., pop-up ads, social media feed, click ads, television ads, radio ads, ads related to a specific media outlet, and the like). The advertising channel may be a communication channel, e.g., an email, a direct mail, a text (SMS) message, an instant message, and social media message, or the like. In another embodiment, the channel may include displaying advertisements on mobile devices of users. In an embodiment, the advertising channel includes channels operated or managed by the provider of the distribution system. For example, a financial institution that is offering the distribution system may include advertising channels including print out on account statements, display on online account registers or bill pay systems, or direct emails based on the registered email of the account holder. Advertising providers that are capable of providing the specified type of advertising channel can be identified based on the criteria. In other embodiments, the one or more advertising providers are identified based on data relating to the offer advertisements. For example, the advertising providers may be based on data related to a payment.

The criteria may also include the geographic scope or location of the advertisement. For example, a first user may desire to target a large geographic area, e.g., the southeastern United States, while a second user may desire to target a smaller geographic area, e.g., a city within the southeastern United States. In an embodiment, a user is able to specify detailed geographic restrictions or requirements for advertisements. In a still further embodiment, the user is able to specify criteria that include only displaying advertisements to a recipient when the recipient is determined to be present at or within a specific geographic location. The user may be determined to be present or within a specific geographic location based on a recipient's log-in to the location (e.g., entering a PIN at an ATM), identification at the location (e.g., at a bank branch counter), social network check-in, or determination of location based on a geopositioning device in the recipient's mobile device.

In a further embodiment, the criteria relate to the timeliness of the advertisement. Some users may desire that the advertisement be implemented immediately, while other users may be willing to wait days or weeks before implementing the advertisement. In another embodiment, timeliness relates to the duration that the advertisement will run. Some advertisers may have restrictions on the duration of the advertisement or an inability to meet the request of the user.

The criteria may further include historical transaction data for recipients. For example, the criteria may include that recipients should have made a purchase at a specific merchant within a predetermined time period (e.g., ever, the past year, the past month, or the like). In this example, a merchant may wish to provide an advertisement to those customers who have already patronized the merchant. In a similar example, the merchant may want to provide an advertisement to customers known to have patronized a competitor of the merchant.

In a still further embodiment, the criteria include costs associated with the advertisement. For example, the criteria may include the total cost for the advertisement, the costs per confirmed contact with a recipient, the cost per channel, or other means of determining a cost associated with the advertisement. In this manner, the user is able to tailor advertisement and advertising campaigns to comply with the user's cost restrictions.

It should be understood that multiple criteria may be selected by a user for an advertisement. Further, the disclosed criteria are merely exemplary and other criteria may be determined by a user. An advantage of the system is flexibility in allowing users to in define advertisement criteria. The providers of the system may have data available that allows targeted selection of recipients of advertisements.

As used herein, the term “advertisement” is to be given a broad scope, unless otherwise defined. An advertisement may be a solicitation, a commercial notice, a request for assistance, or other type of communication between the user or an institution affiliated with the user and recipients. The advertisement may be visual and/or audible. For example, a pop-up window in a webpage may be a type of advertisement. A jingle played while on hold with a financial institution may be a second type of advertisement. A commercial on a television or a video online may be additional types of advertisements. One skilled in the art would be familiar with the concept of advertisements and able to determine various types of advertisements that may be presented to users.

The criteria for the advertisement may be received by the system in a variety of ways. For example, a graphical user interface (GUI) may be provided to the user to allow the user to input criteria for an advertisement. The GUI may be displayed on a webpage, on an ATM screen, or through an application. The application may be run on a computer, tablet computer, or mobile device. The system receives the at least on criteria electronically. In some embodiments, the system directs or assists the user in entering the criteria. For example, a questionnaire process may allow the user to proceed through question and answer screens in a GUI to allow the user to define criteria for the advertisement. For example, the question and answer screens may depict successive levels of criteria that may be selected for the advertisement. The first screen may be timeliness and allow the user to define criteria related to the timeliness of the advertisement or skip this criteria. The second screen may relate to the geographic scope of the advertisement, the third screen may related to the target audience, and so forth. In an embodiment, as the user defines criteria for the advertisement the number of potential advertisers capable of meeting all of the criteria and/or the estimated cost of the advertisement is determined and provided to the user.

As illustrated at block 104, in some embodiments the system determines a subset of advertisers capable of meeting the at least one criteria. In an embodiment, the subset is selected from a plurality of advertisers stored in a database. For example, the provider of the proposal system may access a database comprising a plurality of advertisers and their capabilities. In one embodiment, the database is managed through the provider of the proposal system. In another embodiment, the database is external to the proposal system but access over a network.

In an exemplary embodiment, the subset of advertisers includes advertisers that are capable of meeting all of the user's criteria. For example, the user may have provided four criteria related to an advertisement. The subset of advertisers is selected based on their ability to satisfy or meet each of the criteria. In a further embodiment, however, the subset of advertisers may include a combination of advertisers that in combination may meet all of the criteria. For example, the criteria may include a channel A and a channel B. While a first advertiser in the database may be able to provide advertisements in channel A and a second advertiser in the database may be able to provide advertisements in channel B, the system may determine a subset that includes the combination of the first and second advertiser and thereby meet all of the criteria of the user.

The advertising providers include systems, servers, or any businesses that provide advertising channels or advertising services. Exemplary advertising providers include social media providers, internet providers, web page providers, television networks, cable television or satellite television providers, radio service providers, printed publication providers, organizations that permit advertising, advertising agencies, partners of the advertising providers, application developers, financial institutions, and the like.

As illustrated at block 106, in some embodiments the system requests proposals from the subset of advertisers to provide the advertisement. The system may send the criteria to the subset of advertisers and request that the advertisers prepare a proposal to provide the advertisement while meeting some or all of the criteria. In an embodiment, the advertisers are permitted to provide alternatives, such as alternative channels for advertisement display, that the advertiser believes will be acceptable alternatives to the specified criteria.

In an embodiment, advertisers that are able to meet all of the criteria are determined based on capabilities of advertisers known by the system. For example, a database of advertisers and capabilities may be accessed by the system and the user's criteria matched to the advertiser's capabilities in the database. If a user specifies a distribution channel, a distribution time, and a geographic region for the advertisement, the system may evaluate all of the advertisers in the database and determine which advertisers are able to satisfy each of the criteria. The system then contacts these advertisers, such as via an automated electronic proposal request, and solicits proposals from the advertisers.

It should be understood that in some embodiments the system augments the capabilities of the advertisers. For example, the system may coordinate with the advertisers to target advertisements to specific demographics based on information available to the system provider. In an exemplary embodiment, the system provider is a financial institution having information related to demographics and financial data of customers. The system combines this information with the capabilities of the advertiser to target advertisements based on both user criteria that are able to be met by the advertiser and user criteria that are able to be met by the financial institution.

As illustrated at block 108, in some embodiments the system receives proposals from the advertisers. Once the advertiser receives the criteria and develops a proposal, the advertiser sends the proposal to the system. The system may receive the proposal and immediately forward it on to the user or the system may evaluate the proposal for the user. In one embodiment, the system waits to forward the proposal on to the user until all advertisers have either provided the proposals or indicated that a proposal will not be provided. In an embodiment, a deadline for receiving a proposal is set by the user or the system.

As illustrated at block 110, in some embodiments the system evaluates the proposals to provide an evaluation. For example, the system may use transactional information from customers to evaluate proposals provided by advertisers. The system may access records of previous advertisements or advertising campaigns by the advertiser to determine the effectiveness of the advertisement. In one embodiment, the system compares the history of advertisements with the history of purchases by financial institution customers. In this manner, the system is able to provide an estimate of the effectiveness of a proposed advertising campaign by an advertiser. For example, the advertiser may provide a proposal to solicit individuals through a direct mail campaign in a specific state. The advertiser provides a history of direct mail campaigns for a business in that state to the financial institution as part of the proposal. The system compares the history of the direct mail campaign to transaction records of financial institution customers in the state to determine how many customers made a purchase associated with the business in the state during the time the advertisement was being run. While some purchases may have occurred even if the advertisement had not been run, the system is able to provide an estimate of the effectiveness of the advertisement based on the comparison. In some embodiments, the system also compares the transaction records for users when the advertisement is not being run to determine further information on the effectiveness of the advertisement. For example, a baseline number of purchases, e.g., average number of purchases at the business per month, may be determined when the advertisement is not being run.

In an embodiment, the system provides an evaluation for each proposal based on transaction history of the financial institution customers. The system may also provide a cost efficiency evaluation of the proposal. For example, the effective evaluation of the proposal may provide information on how many financial institution customers may respond to the advertisement but does not evaluate the cost efficiency of the proposal. The system may also evaluate the cost per predicted response of the proposal. In one embodiment, the system predicts how many financial institution customers will conduct a transaction with the business based on the proposed advertisement, using historical transaction data for related advertising campaigns (e.g., similar channels, target demographics, region, and the like), and then provides a cost efficiency evaluation of the proposal. The system may determine that the proposal will result in X numbers of predicted new purchases per dollar spent on the advertisement. The system is able to predict new purchases based on the financial transaction history data available to the system.

As illustrated at block 112, in some embodiments the system provides the proposals and/or the evaluation to the user. In an exemplary embodiment, the system provides the proposals and/or the evaluations of the proposals to the user electronically. For example, the user may log into a webpage that provides the proposals to the users.

In some embodiments, the system receives input from the user selecting a proposal. The user may review the proposals and, if available, the evaluations and then select a proposal that they user would like to pursue. In some embodiments, the user rejects all of the proposals and has the option to cancel the advertisement, change the criteria, or request new proposals from the advertisers.

As illustrated at block 114, in some embodiments the system facilitates an advertisement for the user-selected proposal. If the user selects a proposal, the system may contact the advertiser and initiate the advertisement on behalf of the user. In an exemplary embodiment, the system facilitates the advertisement by managing the payments from the user to the advertiser, as discussed in U.S. patent application Ser. No. ______, filed Jan. 1, 2013, entitled “Distribution of Payments relating to Offer Advertisements” and herein incorporated by reference.

Referring now to FIG. 2, a block diagram illustrating a system and environment 200 for a proposal system for advertisement offerings is provided. For example, the system and environment 200 may receive input from a user 210 and distribute that input through a distribution system 202 to one or more advertising channel systems 240, 250, 260. The advertising channel systems 240, 250, 260 may then communicate back to the distribution system 202, which in turn communicates with the user 201.

As illustrated in FIG. 2, the user 210 sends data to the distribution system 202. For example, the distribution system 202 may receive one or more criteria for an advertisement, which can include the target audience, the channels, the cost, and the like. The distribution system 202, in some embodiments, processes and/or analyzes the data and determines a subset of advertising channel systems from a plurality of advertising channel systems stored in a database 204 which are capable of meeting the criteria. For example, the distribution system 202 may receive criteria including social network distribution as a desired channel for an advertisement. The distribution system determines that the first advertising channel system 240 and the second advertising channel system 250 are capable of distributing advertisement over social networks but that the third advertising channel system 260 is not capable of distributing advertisements over social networks. The distribution system 202 then distributes the user's criteria to the first advertising channel system 240 and the second advertising channel system 250 but not to the third advertising channel system 260. In this way, the distribution process is streamlined such that the user 210 can send data to one source instead of sending the data to multiple sources. In the illustrated embodiment, rather than the user 210 determining targeted recipients and distributing data, the distribution system 202 identifies data recipients and provides the identified recipients with the correct data.

Referring now to FIG. 3, a block diagram illustrates an environment 300 for distributing data relating to offer advertisements. The environment 300 includes the distribution system 202, the first advertising channel 140, and the user 210 of FIG. 2 The environment 300 further includes one or more other users, one or more other advertising channel systems 394 (e.g., the second and third advertising channel systems 250, 260), and one or more external systems 396. The systems and devices communicate with one another over a network 330 and perform one or more of the various steps and/or methods according to embodiments of the invention discussed herein. The network 330 may include a local area network (LAN), a wide area network (WAN), and/or a global area network (GAN). The network 330 may provide for wireline, wireless, or a combination of wireline and wireless communication between devices in the network. In one embodiment, the network 330 includes the Internet.

The distribution system 202, the user 210, and the first advertising channel system 240 each includes a computer system, server, multiple computer systems and/or servers or the like. The distribution system 202, in the embodiments shown has a communication device 342 communicably coupled with a processing device 344, which is also communicably coupled with a memory device 346. The processing device 344 is configured to control the communication device 342 such that the financial institution system 340 communicates across the network 330 with one or more other systems. The processing device 344 is also configured to access the memory device 346 in order to read the computer readable instructions 348, which in some embodiments includes a distribution application 350. The memory device 346 also includes a database 204 for storing pieces of data, such as a plurality of advertising channel system capabilities, that can be accessed by the processing device 344.

As used herein, a “processing device,” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 314, 344, or 364 may further include functionality to operate one or more software programs based on computer-executable program code thereof, which may be stored in a memory. As the phrase is used herein, a processing device 314, 344, or 364 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory device” generally refers to a device or combination of devices that store one or more forms of computer-readable media and/or computer-executable program code/instructions. Computer-readable media is defined in greater detail below. For example, in one embodiment, the memory device 346 includes any computer memory that provides an actual or virtual space to temporarily or permanently store data and/or commands provided to the processing device 344 when it carries out its functions described herein.

In some embodiments, the user 210 utilizes a device that includes a communication device 312 communicably coupled with a processing device 314, which is also communicably coupled with a memory device 316. The processing device 314 is configured to control the communication device 312 such that the user 210 communicates across the network 330 with one or more other systems. The processing device 314 is also configured to access the memory device 316 in order to read the computer readable instructions 318, which in some embodiments includes a distribution application 320. The memory device 316 also includes a database 322 for storing pieces of data, such as criteria for an advertisement, that can be accessed by the processing device 314.

The first advertising channel system 140 includes a communication device 362 communicably coupled with a processing device 364, which is also communicably coupled with a memory device 366. The processing device 364 is configured to control the communication device 362 such that the first advertising channel system 140 communicates across the network 330 with one or more other systems. The processing device 364 is also configured to access the memory device 266 in order to read the computer readable instructions 366, which in some embodiments includes a distribution application 370. The memory device 366 also includes a database 362 for storing pieces of data, such as historical advertisement success data, that can be accessed by the processing device 364.

In some embodiments, the advertising channel distribution channel application 370 and the distribution application 320 interacts with the distribution server distribution application 350 to access information, historical records of advertisement success, criteria, proposals, requests, or other data for use in analyzing and distributing such data. In some embodiments, a data analysis application 352 stored in the memory device 346 of the distribution system 202 retrieves information regarding proposals and/or advertising in determining trends, producing graphs, providing recommendations, and the like.

The applications 320, 350 and 370 are for instructing the processing devices 314, 344 and 364 to perform various steps of the methods discussed herein, and/or other steps and/or similar steps. In various embodiments, one or more of the applications 320, 350 and 370 are included in the computer readable instructions stored in a memory device of one or more systems other than the systems 202, 210, and 240. For example, in some embodiments, the application 320 is stored and configured for being accessed by a processing device of one or more other merchant systems 392 connected to the network 330. In various embodiments, the applications 320, 350 and 370 stored and executed by different systems/devices are different. In some embodiments, the applications 320, 350 and 370 stored and executed by different systems may be similar and may be configured to communicate with one another, and in some embodiments, the applications 320, 350 and 370 may be considered to be working together as a singular application despite being stored and executed on different systems.

In various embodiments, one of the systems discussed above, such as the distribution system 202, is more than one system and the various components of the system are not collocated, and in various embodiments, there are multiple components performing the functions indicated herein as a single device. For example, in one embodiment, multiple processing devices perform the functions of the processing device 344 of the distribution system 202 described herein. In various embodiments, the distribution system 202 includes one or more of the external systems 396 and/or any other system or component used in conjunction with or to perform any of the method steps discussed herein. For example, the distribution system 202 may include a financial institution system, a credit agency system, and the like.

In various embodiments, the distribution system 202, the user 210 system, and the first advertising channel system 240 and/or other systems may perform all or part of a one or more method steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of method 100, the other methods discussed below, or other methods, processes or steps discussed herein or not discussed herein.

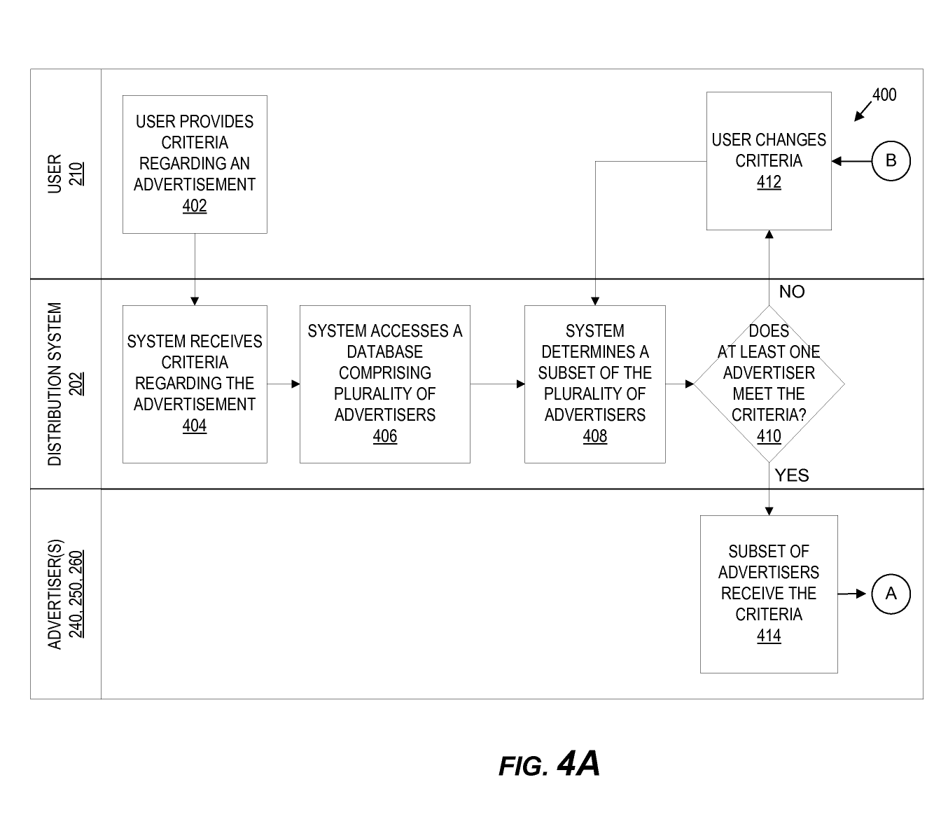

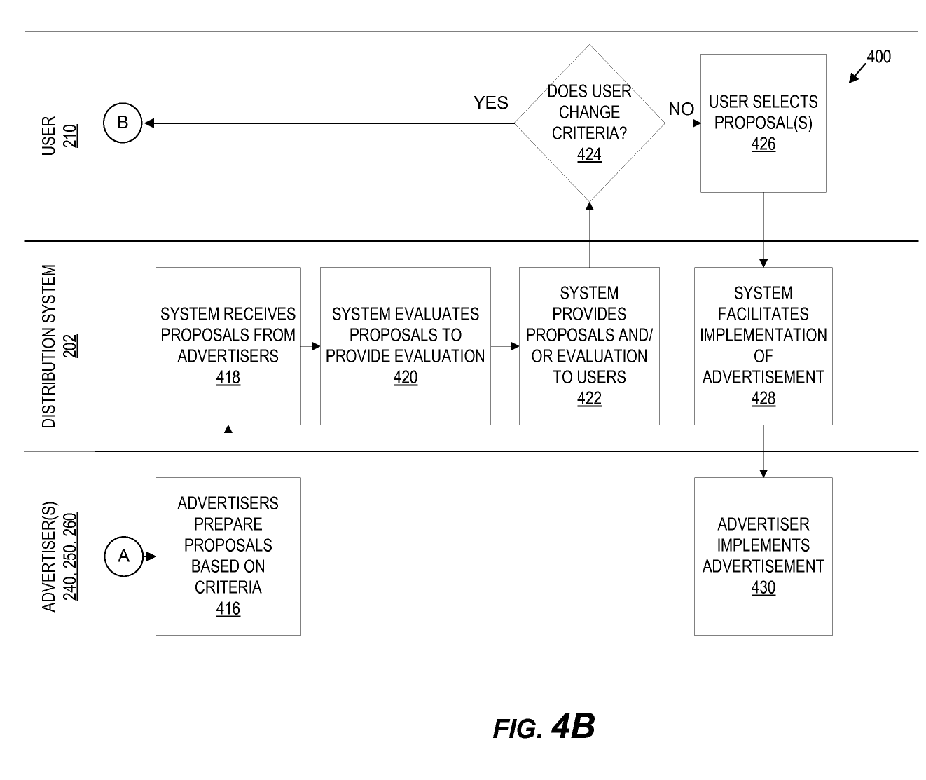

Referring now to FIG. 4, a mixed block and flow diagram for providing a proposal system for advertisement offerings is disclosed, in accordance with an embodiment of the invention. The mixed block and flow diagram discloses the user 210, the distribution system 202, and the advertisers 240, 250, 260 performing various steps in the method, as disclosed herein. It should be understood that the order of the steps and the party depicted as conducting the step may change from the exemplary embodiment disclosed in FIGS. 4A and 4B. For example, the user may change the criteria at any point. Similarly, in some embodiments, the advertisers 240, 250, 260 may provide the proposals directly to the user 210, bypassing the system 202.

As illustrated at block 402, in some embodiments the user provides criteria regarding an advertisement. Exemplary criteria includes targeted audience data, types of advertising channels, images, audio, or text of the advertisements, terms of the offer, product data, terms of the advertisement, contract data, historical data, and the like. In some embodiments, the criteria include a type of advertising channel (e.g., pop-up ads, social media feed, click ads, television ads, radio ads, ads related to a specific media outlet, and the like). The criteria may also include the geographic scope or location of the advertisement. In a further embodiment, the criteria relate to the timeliness of the advertisement. The criteria may further include historical transaction data for recipients. In a still further embodiment, the criteria include costs associated with the advertisement. It should be understood that multiple criteria may be selected by a user for an advertisement. Further, the disclosed criteria are merely exemplary and other criteria may be determined by a user. An advantage of the system is flexibility in allowing users to in define advertisement criteria. The providers of the system may have data available that allows targeted selection of recipients of advertisements.

In some embodiments, the targeted audience is based on customer demographics such as age, ethnicity, social status, legal status, individual or household income, geographical location, education, household size, and the like. In other embodiments, the targeted audience is based on spending activity, group memberships, publicly available social profiles, product ownership data, and the like. For example, demographic data may be combined with spending activity, group memberships, social profiles and/or product ownership data to identify the target audience. Single college students under age 27, for example, may purchase gaming equipment much more frequently than other individuals. Based on such findings, the target audience for offers for computer games and equipment may be directed to individuals having an age range of 19 to 28 and who live within a 20 mile radius of a university.

As illustrated at block 404, in some embodiments the system receives the criteria regarding the advertisement. For example, a graphical user interface (GUI) may be provided to the user to allow the user to input criteria for an advertisement. In some embodiments, the system directs or assists the user in entering the criteria. For example, a questionnaire process may allow the user to proceed through question and answer screens in a GUI to allow the user to define criteria for the advertisement. For example, the question and answer screens may depict successive levels of criteria that may be selected for the advertisement. The first screen may be timeliness and allow the user to define criteria related to the timeliness of the advertisement or skip this criteria. The second screen may relate to the geographic scope of the advertisement, the third screen may related to the target audience, and so forth. In an embodiment, as the user defines criteria for the advertisement the number of potential advertisers capable of meeting all of the criteria and/or the estimated cost of the advertisement is determined and provided to the user.

As illustrated at block 406, in some embodiments the system accesses a database comprising a plurality of advertisers. The database may include capabilities of the advertisers and historical data regarding previous advertising campaigns. The database may also include business activity associated with previous advertising campaigns that the system may use to evaluate the effectiveness of proposals. The business activity includes merchant exposure, number of redeemed offers, number of advertising views or web page views, number of clicks associated with the advertising, total number of advertising viewers, number of targeted audience that have been exposed to the advertising, increases or decreases in sales, increases or decreases in online traffic on merchant's website, increases or decreases in foot traffic at merchant's store, number of new customers, amount and type of feedback, and the like.

The proposed target audience of the advertisement, in some embodiments, includes exposure to non-customers or existing customers. Gauging this type of activity can indicate the value of the advertisement. For example, an increase in merchant exposure to non-customers may result in potential new customers, while an increase in exposure to existing customers can provide incentives to these customers and increase sales. The audience the merchant seeks to target with the advertisement can also be a beneficial indicator. The targeted audience includes, for example, non-customers, inactive customers, and existing customers.

Further, the amount of business activity in one category can be used to determine increases or decreases in business activity associated with other categories. For example an increase in sales or offer redemptions of one product can cause a permanent or temporary increase or decrease in sales of another product. If the merchant has a partnership with a certain manufacturer of a product, has a large inventory of the product, or if the merchant can make a larger profit by selling the product over another product, the merchant may direct offer advertising to the one product to increase sales of the product and/or reduce sales of another product. In other examples, the merchant may increase sales of a particular product by decreasing or terminating offer advertising of a similar product and/or increasing offer advertising for the particular product. In still other examples, the merchant may increase overall sales or traffic to their stores or online web sites by providing attractive incentives for a popular item.

In an embodiment, the system recommends specific criteria to assist the user. The recommendations include, for example, a type of offer, at type of product, a type of advertising channel, targeted audience, period of time to the run the offer advertisements, length of advertisements, frequency advertisement are broadcasted, and the like. For example, a recommendation that the merchant offer discounts to purchasers over 65 may be provided so that the merchant can increase their customer base based on business activity in certain demographic categories. In other examples, specific offer terms may be suggested to the merchant based on the success rates of certain types of offers. If an offer directed to incentivizing the customer to buy a greater quantity of items to get a discount does not result in an increase in sales, for example, a recommendation that a discount be applied to single items may be provided.

As illustrated at block 408, in some embodiments the system determines a subset of the plurality of advertisers. In an embodiment, the subset is selected from a plurality of advertisers stored in a database. For example, the provider of the proposal system may access a database comprising a plurality of advertisers and their capabilities. In one embodiment, the database is managed through the provider of the proposal system. In another embodiment, the database is external to the proposal system but access over a network. In an exemplary embodiment, the subset of advertisers includes advertisers that are capable of meeting all of the user's criteria.

As illustrated at decision block 410, in some embodiments the system determines whether at least one advertiser meets the criteria. For example, the user may have provided four criteria related to an advertisement. The subset of advertisers is selected based on their ability to satisfy or meet each of the criteria. In a further embodiment, however, the subset of advertisers may include a combination of advertisers that in combination may meet all of the criteria.

As illustrated at block 412, if at least one advertiser does not meet the criteria the system informs the user of this fact and allows the user to change the criteria.

If, however, at least one advertiser meets the criteria, then as illustrated at block 414, the subset of advertisers receive the criteria. In some embodiments the system requests proposals from the subset of advertisers to provide the advertisement. The system may send the criteria to the subset of advertisers and request that the advertisers prepare a proposal to provide the advertisement while meeting some or all of the criteria. In an embodiment, the advertisers are permitted to provide alternatives, such as alternative channels for advertisement display, that the advertiser believes will be acceptable alternatives to the specified criteria.

As illustrated at block 416, in some embodiments the advertisers prepare proposals based on the criteria. The advertisers may provide alternative options or enhanced capabilities in addition to meeting the criteria. In a further embodiment, the advertiser provides a historical record of similar advertisements as part of the proposal. The system may request his historical record as part of the request for proposals to assist the system in evaluating the proposal.

As illustrated at block 418, in some embodiments the system receives proposals from advertisers. Once the advertiser receives the criteria and develops a proposal, the advertiser sends the proposal to the system. The system may receive the proposal and immediately forward it on to the user or the system may evaluate the proposal for the user. In one embodiment, the system waits to forward the proposal on to the user until all advertisers have either provided the proposals or indicated that a proposal will not be provided. In an embodiment, a deadline for receiving a proposal is set by the user or the system.

As illustrated at block 420, in some embodiments the system evaluates the proposals to provide an evaluation. The system may access records of previous advertisements or advertising campaigns by the advertiser to determine the effectiveness of the advertisement. In one embodiment, the system compares the history of advertisements with the history of purchases by financial institution customers. In this manner, the system is able to provide an estimate of the effectiveness of a proposed advertising campaign by an advertiser. In some embodiments, the system also compares the transaction records for users when the advertisement is not being run to determine further information on the effectiveness of the advertisement. In an embodiment, the system provides an evaluation for each proposal based on transaction history of the financial institution customers. The system may also provide a cost efficiency evaluation of the proposal.

As illustrated at block 422, in some embodiments the system provides the proposals and/or evaluations to the user. In an exemplary embodiment, the system provides the proposals and/or the evaluations of the proposals to the user electronically. For example, the user may log into a webpage that provides the proposals to the users. The system may also provide the proposals to the user via mail, email, or through a mobile device application.

As illustrated at decision block 424, in some embodiments the user changes the criteria after receiving the proposals and/or the evaluations. For example, none of the proposals may be acceptable to the user and thus the user modifies the criteria to receive a new set of proposals.

As illustrated at block 426, in some embodiments if the user does not change criteria and does not reject all proposals, the user selects at least one proposal to move forward with. The user may select the one or more proposals using a graphical user interface.

As illustrated at block 428, in some embodiments the system facilitates implementation of the advertisement. If the user selects a proposal, the system may contact the advertiser and initiate the advertisement on behalf of the user. In an exemplary embodiment, the system facilitates the advertisement by managing the payments from the user to the advertiser.

As illustrated at block 430, in some embodiments the advertiser implements the advertisement. In other words, the advertiser runs the advertisement based on the criteria established by the user. In a further embodiment, the results of the advertisement are continuously monitored (e.g., page hits, number of purchases, and the like) and provided to the user.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated. Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A bid system for advertisement offerings, the system comprising:
a computer apparatus including a processor and a memory; and
a software module stored in the memory, comprising executable instructions that when executed by the processor cause the processor to:
receive at least one criteria for an advertisement from a user;
determine a subset of advertisers from a plurality of advertisers stored in a database, wherein the subset of advertisers are determined based on the at least one criteria;
request proposals from the subset of advertisers to provide the advertisement;
receive proposals from the advertisers in response to the request for proposals; and
provide the proposals to the user.

2. The system of claim 1, further comprising executable instructions that when executed by the processor cause the processor to evaluate the proposals and provide an evaluation of the proposals to the user.

3. The system of claim 2, wherein the system evaluates the proposals based on historic advertisement and response data, and wherein the response data is based on transaction history data provided by a financial institution.

4. The system of claim 2, wherein the evaluation provides an evaluation of the proposal based on an effectiveness of the advertisement and a cost efficiency of the advertisement.

5. The system of claim 1, wherein the system provides suggested criteria to the user based on historical transaction data of customers.

6. The system of claim 1, wherein the module is further configured to:
receive advertising data from the advertising provider, wherein the advertising data is associated with a previous advertising campaign.

7. The system of claim 6, wherein the previous advertising campaign meets at least one of the criteria of the user.

8. A computer program product for providing a bid system for advertisement offerings, the computer program product comprising:
a non-transitory computer readable storage medium having computer readable program code embodied therewith, the computer readable program code comprising:
computer readable program code configured to receive at least one criteria for an advertisement from a user;
computer readable program code configured to determine a subset of advertisers from a plurality of advertisers stored in a database, wherein the subset of advertisers are determined based on the at least one criteria;
computer readable program code configured to request proposals from the subset of advertisers to provide the advertisement;
computer readable program code configured to receive proposals from the advertisers in response to the request for proposals; and
computer readable program code configured to provide the proposals to the user.

9. The computer program product of claim 8, further comprising computer readable program code configured to evaluate the proposals and provide an evaluation of the proposals to the user.

10. The computer program product of claim 9, wherein the computer program product evaluates the proposals based on historic advertisement and response data, and wherein the response data is based on transaction history data provided by a financial institution.

11. The computer program product of claim 9, wherein the evaluation provides an evaluation of the proposal based on an effectiveness of the advertisement and a cost efficiency of the advertisement

12. The computer program product of claim 8, further comprising computer readable program code configured to receive advertising data from the advertising provider, wherein the advertising data is associated with a previous advertising campaign.

13. The computer program product of claim 12, wherein the previous advertising campaign meets at least one of the criteria of the user.

14. A method for providing a bid system for advertisement offerings, the method comprising:
receiving at least one criteria for an advertisement from a user;
determining, via a computing device processor, a subset of advertisers from a plurality of advertisers stored in a database, wherein the subset of advertisers are determined based on the at least one criteria;
requesting proposals from the subset of advertisers to provide the advertisement;
receiving proposals from the advertisers in response to the request for proposals; and
providing the proposals to the user.

15. The method of claim 14, further comprising:
evaluating the proposals; and
providing an evaluation of the proposals to the user.

16. The method of claim 15, wherein the method evaluates the proposals based on historic advertisement and response data, and wherein the response data is based on transaction history data provided by a financial institution.

17. The method of claim 15, wherein the evaluation provides an evaluation of the proposal based on an effectiveness of the advertisement and a cost efficiency of the advertisement.

18. The method of claim 14, further comprising providing suggested criteria to the user based on historical transaction data of customers.

19. The method of claim 14, further comprising receiving advertising data from the advertising provider, wherein the advertising data is associated with a previous advertising campaign.

20. The method of claim 19, wherein the previous advertising campaign meets at least one of the criteria of the user.
